(19) United States
(12) Patent Application Publication
(10) Pub. No.: US 2004/0143434 A1
(43) Pub. Date: Jul. 22, 2004

(54) Audio-Assisted segmentation and browsing of news videos

(76) Inventors: Ajay Divakaran, Burlington, MA (US); Regunathan Radhakrishnan, Arlington, MA (US)

Correspondence Address: Patent Department, Mitsubishi Electric Research Laboratories, Inc., 8th Floor, 201 Broadway, Cambridge, MA, 02139, US

(21) Appl. No.: 10/346,419

(22) Filed: Jan. 17, 2003

(51) Int. Cl. G10L 15/14

(52) U.S. Cl. 704/256

(57) ABSTRACT

A method segments and summarizes a news video using both audio and visual features extracted from the video. The summaries can be used to quickly browse the video to locate topics of interest. A generalized sound recognition hidden Markov model (HMM) framework for joint segmentation and classification of the audio signal of the news video is used. The HMM not only provides a classification label for audio segment, but also compact state duration histogram descriptors.

Using these descriptors, contiguous male and female speech segments are clustered to detect different news presenters in the video. Second level clustering is performed using motion activity and color to establish correspondences between distinct speaker clusters obtained from the audio analysis. Presenters are then identified as those clusters that either occupy a significant period of time, or clusters that appear at different times throughout the news video. Identification of presenters marks the beginning and ending of semantic boundaries. The semantic boundaries are used to generate a hierarchical summary of the news video for fast browsing.

### FIELD OF THE INVENTION

This invention relates generally to segmenting and browsing g videos, and more particularly to audio-assisted segmentation, summarization and browsing of news videos.

### BACKGROUND OF THE INVENTION

Prior art systems for browsing a news video typically rely on detecting transitions of news presenters to locate different topics or news stories. If the transitions are marked in the video, then a user can quickly skip from topic to topic until a desired topic is located.

Transition detection is usually done by applying high-level heuristics to text extracted from the news video. The text can be extracted from closed caption information, embedded captions, a speech recognition system, or combinations thereof, see Hanjalic et al., “Dancers: Delft advanced news retrieval system,” IS&T/SPIE Electronic Imaging 2001: Storage and retrieval for Media Databases, 2001, and Jasinschi et al., “Integrated multimedia processing for topic segmentation and classification,” ICIP-2001, pp. 366-369, 2001.

Presenter detection can also be done from low-level audio and visual features, such as image color, motion, and texture. For example, portions of the audio signal are first clustered and classified as speech or non-speech. The speech portions are used to train a Gaussian mixture model (GMM) for each speaker. Then, the speech portions can be segmented according to the different GMMS to detect the various presenters, see Wang et al., “Multimedia Content Analysis,” IEEE Signal Processing Magazine, November 2000. Such techniques are often computationally intensive and do not make use of domain knowledge.

Another motion-based video browsing system relies on the availability of a topic list for the news video, along with the starting and ending frame numbers of the different topics, see Divakaran et al., “Content Based Browsing System for Personal Video Recorders,” IEEE International Conference on Consumer Electronics (ICCE), June 2002. The primary advantage of that system is that it is computationally inexpensive because it operates in the compressed domain. If video segments are obtained from the topic list, then visual summaries can be generated. Otherwise, the video can be partitioned into equal sized segments before summarization. However, the later approach is inconsistent with the semantic segmentation of the content, and hence, inconvenient for the user.

Therefore, there is a need for a system that can reliably detect transitions between news presenters to locate topics of interest in a news video. Then, the video can be segmented and summarized to facilitate browsing.

### SUMMARY OF THE INVENTION

The invention provides a method for segmenting and summarizing a news video using both audio and visual features extracted from the video. The summaries can be used to quickly browse the video to locate topics of interest.

The invention uses a generalized sound recognition hidden Markov model (HMM) framework for joint segmentation and classification of the audio signal of the news video. The HMM not only provides a classification label for audio segment, but also compact state duration histogram descriptors.

Using these descriptors, contiguous male and female speech segments are clustered to detect different news presenters in the video. Second level clustering is performed using motion activity and color to establish correspondences between distinct speaker clusters obtained from the audio analysis.

Presenters are then identified as those clusters that either occupy a significant period of time, or clusters that appear at different times throughout the news video.

Identification of presenters marks the beginning and ending of semantic boundaries. The semantic boundaries are used to generate a hierarchical summary of the news video for fast browsing.

### BRIEF DESCRIPTION OF THE DRAWINGS

FIG. 1 is a flow diagram of a method for segmenting, summarizing, and browsing a news video according to the invention;

FIG. 2 is a flow diagram of a procedure for extracting, classifying and clustering audio features;

FIG. 3 is a first level dendogram; and

FIG. 4 is a second level dendogram.

### DETAILED DESCRIPTION OF THE PREFERRED EMBODIMENT

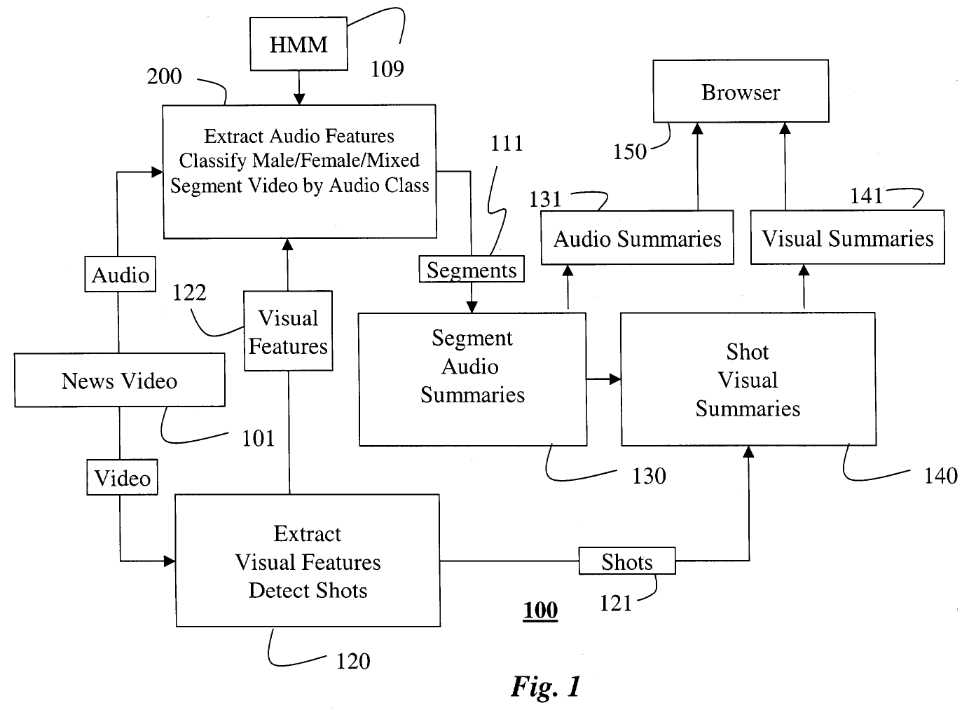

FIG. 1 shows a method 100 for browsing a news video according to the invention.

In step 200, audio features are extracted from an input news video 101. The audio features are classified as either male speech, female speech, or speech mixed with music, using trained hidden Markov models (HMM) 109.

Portions of the audio signal with the same classification are clustered. The clustering is aided by visual features 122 extracted from the video. Then, the video 101 can be partitioned into segments 111 according to the clustering.

In step 120, the visual features 122, e.g., motion activity and color are extracted from the video 101. The visual features are also used to detect shots 121 or scene changes in the video 101.

In step 130, audio summaries 131 are generated for each audio segment 111. Each summary can be a small portion of the audio signal, at the beginning of a segment, where the presenter usually introduces a new topic. Visual summaries 141 are generated for each shot 121 in each audio segment 111.

A browser 150 can now be used to quickly select topics of interest using the audio summaries 131, and selected topics can scanned using the visual summaries 141.

Audio Segmentation

Training

News contains mainly three audio classes, male speech, female speech and speech mixed with music. Therefore, example audio signals for each class are manually labeled and classified from training news videos. The audio signals are all mono-channel, 16 bits per sample with a sampling rate of 16 KHz. Most of the training videos, e.g., 90%, are used to train the HMM 109, the rest are used to validate the training of the models. The number of states in each HMM 109 is ten, and each state is modeled by a single multivariate Gaussian distribution. A state duration histogram descriptor can be associated with a Gaussian mixture model (GMM) when the HMM states are represented by a single Gaussian distribution.

Audio Feature Extraction

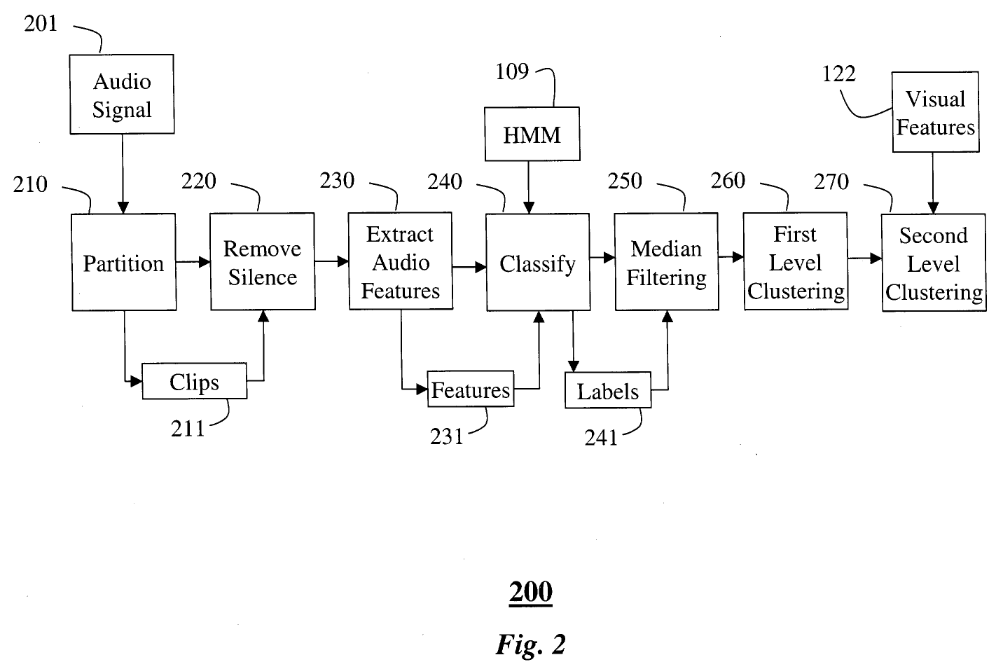

FIG. 2 shows the detail of the audio feature extraction, classification, and clustering. The input audio signal 201 from the news video 101 is partitioned 210 into short clips 211, e.g., three seconds, so that the clips are relatively homogenous. Silent clips are removed 220. Silence clips are those with an audio energy less than some predetermined threshold.

For each non-silent clip, MPEG-7 audio features 231 are extracted 230 as follows. Each clip is divided into 30 ms frames with a 10 ms overlap for adjacent frames. Then, each frame is multiplied by a hamming window function:

wᵢ=(0.5−0.46 cos(2πᵢ/N)), for 1≦i≦N,

where N is the number of samples in the window.

After performing a FFT on each windowed frame, energy in each sub-band is determined, and a resulting vector is projected onto the first 10 principal components of each audio class.

For additional details see Casey, “MPEG-7 Sound-Recognition Tools,” IEEE Transactions on Circuits and Systems for Video Technology, Vol. 11, No.6, June 2001, and U.S. Pat. No. 6,321,200, incorporated herein by reference.

Classification

Viterbi decoding is performed to classify 240 the audio features using the labeled models 109. The label 241 of the model with a maximum likelihood value is selected for classification.

Median filtering 250 is applied to the labels 241 obtained for each three second clip to impose a time continuity constraint. The constraint eliminates spurious changes in speakers.

In order to identify individual speakers within the male and female audio classes, sound class, unsupervised clustering of the labeled clips is performed based on the MPEG-7 state duration histogram descriptor. Each classified sub-clip is associated with a state duration histogram descriptor. The state duration histogram can be interpreted as a modified representation of a Gaussian mixture model (GMM).

Each state in the trained HMM 109 can be considered as cluster in feature space, which can be modeled by a single Gaussian distribution or probability density function. The state duration histogram represents the probability of occurrence of a particular state. This probability is interpreted as the probability of a mixture component in a GMM.

Thus, the state duration histogram descriptor can be considered as a reduced representation of the GMM, which in its unsimplified form is known to be a good model for speech, see Reynolds et al., “Robust Text Independent Speaker Identification Using Gaussian Mixture Speaker Models”, IEEE Transactions on Speech and Audio Processing, Vol.3, No. 1, January 1995.

Because the histogram is derived from the HMM, it also captures some temporal dynamics which a GMM cannot. There, this descriptor is used to identify clusters belonging to different speakers in each audio class.

Clustering

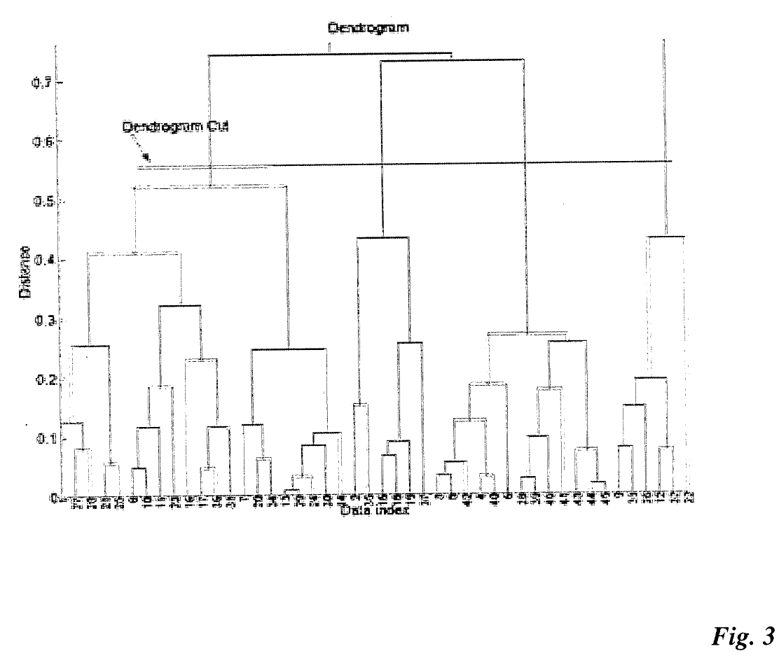

For each contiguous set of identical labels, after filtering, first level clustering 260 is performed using the state duration histogram descriptor. As shown in FIG. 3, the clustering uses an agglomerative dendogram 300 constructed in a bottom-up manner as follows. The dendogram shows indexed clips along the x-axis, and distance along the y-axis.

First, a distance matrix is obtained by measuring pairwise distance between all clips to be clustered. The distance metric is a modification of the well known Kullback-Leibler distance. The distances compare two probability density functions (pdf).

The modified Kullback-Leibler distance between two pdfs H and K is defined as:

D(H, K))=Σhᵢ log(hᵢ/mᵢ)+mᵢ log(kᵢ/mᵢ),

where mᵢ=(hᵢ+kᵢ)/2, and 1≦i≦N is the number of bins in the histogram.

Then, the dendrogram 300 is constructed by merging the two “closest” clusters according to the distance matrix, until there is only one cluster.

The dendrogram is cut at a particular level 301, relative to a maximum height of the dendrogram, to obtain clusters of individual speakers. Clustering is done only on contiguous male and female speech clips. The clips labels as mixed speech and music are discarded.

After the corresponding clusters have are merged, it is easy to identify individual news presenters, and hence, infer semantic boundaries.

Visual Feature Extraction

The visual features 122 are extracted from the video 101 in the compressed domain. The features include MPEG-7 intensities of motion activity for each P-frame, and a 64 bin color histogram for each I-frame. The motion features are used to identify the shots 141, using standard scene change detection methods, e.g., see U.S. patent application Ser. No. 10/046,790, filed on Jan. 15, 2002 by Cabasson, et al. and incorporated herein by reference.

A second level of clustering 270 establishes correspondences between clusters from two distinct portions. The second level clustering can use color features.

In order to obtain correspondence between speaker clusters from distinct portions of the news program, each speaker cluster is associated with a color histogram, obtained from a frame with motion activity less than a predetermined threshold. Obtaining a frame from a low-motion sequence increases the likelihood that the sequence is of a “talking-head.”

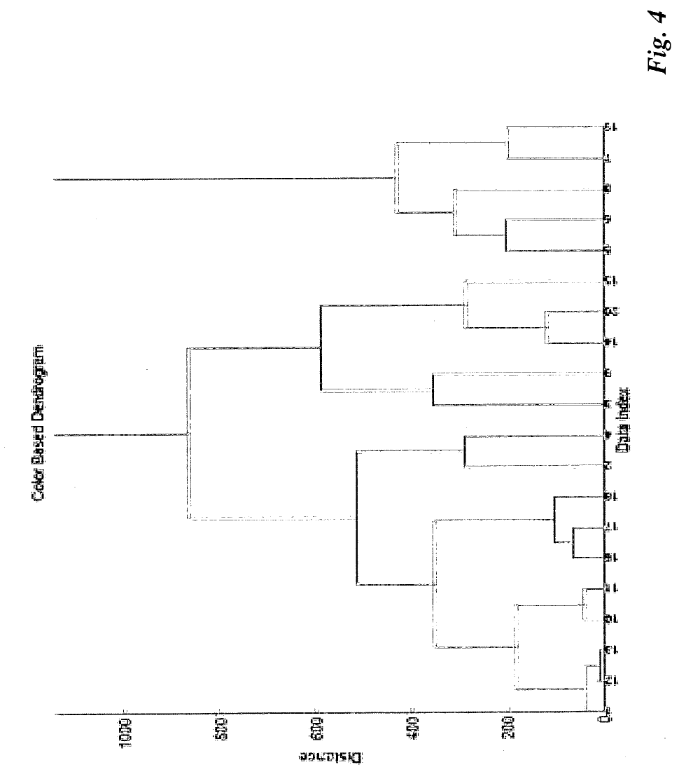

The second clustering based on he color histogram is used to further merge clusters obtained from the audio features. FIG. 4 shows the second level clustering results.

After this step, news presenters can be associated with clusters that occupy a significant period of time, or clusters that appear at different times throughout the news program.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention

1. A method identifying transitions of news presenters in a news video, comprising:
partitioning a news video into a plurality of clips;
extracting audio features from each clip;
classifying each clip as either male speech, female speech, or mixed speech and music;
first clustering the clips labeled as male speech and female speech into a first level of clusters;
extracting visual feature from the news video;
second clustering the first level clusters into second level clusters using the visual features, the second level clusters representing different news presenters in the news video.
